(19) United States
(12) Patent Application Publication
(10) Pub. No.: US 2025/0074244 A1
(43) Pub. Date: Mar. 6, 2025

(54) SYSTEM AND METHOD FOR CHARGING OF ELECTRIC MOBILITY APPARATUS

(71) Applicants: HYUNDAI MOTOR COMPANY, SEOUL (KR); KIA CORPORATION, SEOUL (KR)

(72) Inventor: Won Jae Lee, Hwaseong-si (KR)

(73) Assignees: HYUNDAI MOTOR COMPANY, SEOUL (KR); KIA CORPORATION, SEOUL (KR)

(21) Appl. No.: 18/822,887

(22) Filed: Sep. 3, 2024

(30) Foreign Application Priority Data
Sep. 6, 2023 (KR) 10-2023-0118293

(51) Int. Cl. B60L 53/62; B60L 53/16; B60L 53/66

(52) U.S. Cl. CPC B60L 53/62; B60L 53/16; B60L 53/66; B60L 2200/28; B60L 2240/545; B60L 2250/26

(57) ABSTRACT

A charging system and method release electrical connection of an electric mobility apparatus to a trailer type auxiliary battery connected to an external charger when a dangerous situation occurs in a state of recharging a battery of the electric mobility apparatus, thereby avoiding a dangerous situation.

### CROSS REFERENCE TO RELATED APPLICATIONS

This application claims the benefit of Korean Patent Application No. 10-2023-0118293, filed on Sep. 6, 2023, which is hereby incorporated by reference as if fully set forth herein.

### BACKGROUND

### Field

The present disclosure relates to a system and a method for charging of an electric mobility apparatus.

### Discussion of the Related Art

As shown in FIG. 7, an electric mobility apparatus such as an electric vehicle includes a high-voltage battery 10, an inverter 20 configured to convert direct current (DC) power output from the high-voltage battery 10 into alternating current (AC) power, and a drive motor 30 configured to receive the AC power, thereby supplying drive force to one or more of front wheels and rear wheels of the electric mobility apparatus.

Here, the high-voltage battery 10 mounted in the electric mobility apparatus uses an external charger as a general charging system thereof.

In other words, when the driver desires to recharge the high-voltage battery 10 during driving of the electric mobility apparatus, the driver parks the electric mobility apparatus at a station where an external charger is installed.

The driver then connects a charging cable of the external charger to the electric mobility apparatus and, as such, recharging of the high-voltage battery 10 mounted in the electric mobility apparatus may be carried out.

Meanwhile, during recharging of the high-voltage battery 10, the electric mobility apparatus is in a driving-impossible state.

When a dangerous situation occurs in this state, there may be a problem in that it may not be possible to cope with the dangerous situation.

Here, the dangerous situation may be a situation in which the high-voltage battery 10 being recharged or a connection portion thereof to the external charger is overheated, a situation in which an unidentified person approaches the electric mobility apparatus during recharging of the high-voltage battery 10, etc.

To this end, the present disclosure is intended to provide a technology for charging of the electric mobility apparatus capable of coping with a dangerous situation occurring during recharging of the high-voltage battery 10.

### SUMMARY

Accordingly, the present disclosure is directed to a system and a method for charging of an electric mobility apparatus that substantially obviate one or more problems due to limitations and disadvantages of the related art.

It is an object of the present disclosure to provide a technology capable of releasing electrical connection of an electric mobility apparatus to a trailer type auxiliary battery connected to an external charger when a dangerous situation occurs in a state of recharging a high-voltage battery of the electric mobility apparatus, thereby avoiding a dangerous situation.

Objects of the present disclosure are not limited to the above-described object, and other objects of the present disclosure not yet described will be more clearly understood by those skilled in the art from the following detailed description.

To achieve these objects and other advantages and in accordance with the purpose of the disclosure, as embodied and broadly described herein, there is provided a charging system of an electric mobility apparatus including a first connector releasably connected to a second connector of an add-on electric mobility apparatus, a first battery configured to supply electric power to a first drive motor of the electric mobility apparatus, and a charging controller configured to transmit charging power input through the first connector to the first battery, thereby recharging the first battery with the transmitted charging power, and to transmit a charging stop signal requesting supply stop of the charging power to the add-on electric mobility apparatus when a predetermined emergency charging stop condition is satisfied during the recharging of the first battery.

In at least one embodiment of the present disclosure, the charging controller recharges the first battery in an EV READY state.

In at least one embodiment of the present disclosure, the charging system may further include a connector locker configured to lock or unlock connection between the first connector and the second connector, wherein the charging controller controls the connector locker to lock the connection during the recharging of the first battery, and unlock the connection after transmitting the charging stop signal to the add-on electric mobility apparatus.

In at least one embodiment of the present disclosure, the charging controller controls the first drive motor to be driven after the connector locker unlock the connection.

In at least one embodiment of the present disclosure, the emergency charging stop condition comprises one or more of a first condition that an impact amount sensed by an impact sensor of the electric mobility apparatus is equal to or greater than a predetermined first reference value or a second condition that a time period taken for an object sensor of the electric mobility apparatus to continuously sense one or more objects is equal to or greater than a predetermined second reference value.

In at least one embodiment of the present disclosure, the charging controller outputs a notification message when one or more of the first condition or the second condition are satisfied, and transmits the charging stop signal to the add-on electric mobility apparatus upon receiving a response signal of a driver to the notification message.

In at least one embodiment of the present disclosure, the response signal comprises one or more of an accelerator position sensor (APS) signal as to accelerator pedal manipulation of the driver or a function selection signal as to audio, video and navigation (AVN) device manipulation of the driver.

In at least one embodiment of the present disclosure, the emergency charging stop condition further comprises a third condition that a first battery temperature of the first battery is equal to or greater than a predetermined third reference value, a fourth condition that a first state of charge (SoC) of the first battery is equal to or greater than a predetermined fourth reference value, a fifth condition that a first connector temperature of the first connector is equal to or greater than a predetermined fifth reference value, or a sixth condition that a charging current amount is equal to or greater than a predetermined sixth reference value.

In at least one embodiment of the present disclosure, upon determining that one or more of the third, fourth, fifth, or sixth condition are satisfied, the charging controller controls the connector locker to unlock the connection, and then controls the first drive motor to be driven, thereby causing the electric mobility apparatus to be spaced apart from the add-on electric mobility apparatus by a predetermined distance or more.

In at least one embodiment of the present disclosure, the add-on electric mobility apparatus comprises a right wheel, a left wheel, a second drive motor configured to supply drive force to one or more of the right wheel and the left wheel, a second battery configured to supply electric power to the second drive motor and to output the charging power to the second connector, a discharge switch circuit configured to electrically interconnect the second connector and the second battery in an ON state thereof while disconnecting electrical connection between the second connector and the second battery in an OFF state thereof, and a discharge controller configured to control ON/OFF state of the discharge switch circuit, wherein the discharge controller switches the discharge switch circuit from the ON state to the OFF state upon receiving the charging stop signal through the second connector.

In at least one embodiment of the present disclosure, the discharge controller may control the discharge switch circuit to be in an ON state or an OFF state, in an IG ON state.

In another aspect of the present disclosure, a method of charging an electric mobility apparatus includes receiving charging power from an add-on electric mobility apparatus through a first connector releasably connected to a second connector of the add-on electric mobility apparatus, recharging a first battery of the electric mobility apparatus with the charging power, and transmitting a charging stop signal requesting supply stop of the charging power to the add-on electric mobility apparatus when a predetermined emergency charging stop condition is satisfied during the recharging of the first battery.

In at least one embodiment of the present disclosure, in the recharging, the electric mobility apparatus recharges the first battery in an EV READY state.

In at least one embodiment of the present disclosure, the method may further include unlocking connection between the first connector and the second connector after the transmitting.

In at least one embodiment of the present disclosure, the emergency charging stop condition comprises one or more of a first condition that an impact amount sensed by an impact sensor of the electric mobility apparatus is equal to or greater than a predetermined first reference value or a second condition that a time period taken for an object sensor of the electric mobility apparatus to continuously sense one or more objects is equal to or greater than a predetermined second reference value.

In at least one embodiment of the present disclosure, the transmitting comprises outputting a notification message when one or more of the first condition or the second condition are satisfied, and transmitting the charging stop signal to the add-on electric mobility apparatus upon identifying a response signal of a driver to the notification message.

In at least one embodiment of the present disclosure, the emergency charging stop condition further comprises a third condition that a first battery temperature of the first battery is equal to or greater than a predetermined third reference value, a fourth condition that a first state of charge (SoC) of the first battery is equal to or greater than a predetermined fourth reference value, a fifth condition that a first connector temperature of the first connector is equal to or greater than a predetermined fifth reference value, or a sixth condition that a charging current amount is equal to or greater than a predetermined sixth reference value.

In at least one embodiment of the present disclosure, the method may further include unlocking the connection between the first connector and the second connector after the transmitting, and performing autonomous driving, thereby causing the electric mobility apparatus to be spaced apart from the add-on electric mobility apparatus by a predetermined distance or more.

In at least one embodiment of the present disclosure, the add-on electric mobility apparatus supplies the charging power in an IG ON state, stops supply of the charging power upon receiving the charging stop signal from the electric mobility apparatus, and is then switched to an IG OFF state.

In another aspect of the present disclosure, a method of charging an electric mobility apparatus includes receiving charging power from an add-on electric mobility apparatus through a first connector releasably connected to a second connector of the add-on electric mobility apparatus, recharging a first battery of the electric mobility apparatus with the charging power, receiving, from the add-on electric mobility apparatus, an abnormality generation signal informing of abnormal discharge of electric power of the add-on electric mobility apparatus, unlocking connection between the first connector and the second connector, and performing autonomous driving, thereby causing the electric mobility apparatus to be spaced apart from the add-on electric mobility apparatus by a predetermined distance or more.

### BRIEF DESCRIPTION OF THE FIGURES

The accompanying drawings, which are included to provide a further understanding of the disclosure and are incorporated in and constitute a part of this application, illustrate embodiment(s) of the disclosure and along with the description serve to explain the principle of the disclosure. In the drawings:

FIG. 1 is a view for briefly describing a charging system of an electric mobility apparatus according to an embodiment;

FIG. 2 is a view showing a charging system of an electric mobility apparatus according to an embodiment;

FIG. 3 is a flowchart showing a procedure of coping with a first dangerous situation occurring during charging of an electric mobility apparatus in accordance with an embodiment;

FIG. 4 is a flowchart showing a procedure of coping with the first dangerous situation based on a response of a driver in the electric mobility apparatus in accordance with an embodiment;

FIG. 5 is a flowchart showing an additional procedure of coping with the first dangerous situation in the mobility apparatus in accordance with an embodiment;

FIG. 6 is a flowchart showing a procedure of coping with a second dangerous situation in the mobility apparatus during charging in accordance with an embodiment; and

FIG. 7 is a view showing a configuration of a general electric mobility apparatus.

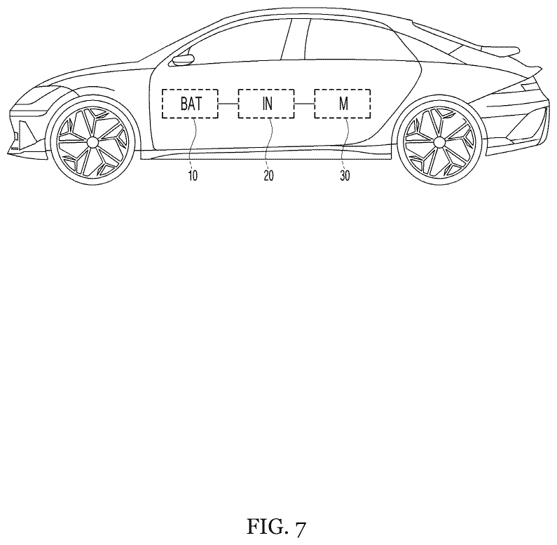

### DETAILED DESCRIPTION

The present disclosure may be modified in various ways and provide various embodiments. Accordingly, the present disclosure will be described below through a detailed description of specific embodiments illustrated in the accompanying drawings. However, the detailed description is not intended to limit the present disclosure to the specific embodiments, and it should be understood that the present disclosure includes all changes, equivalents, or substitutions within the spirit and scope of the present disclosure.

The suffixes “module” and “unit” used herein are used only for distinguishment between constituent elements and, as such, should not be interpreted as representing that the constituent elements are physically and chemically distinguished or separated from each other or as suggesting that the constituent elements are distinguishable or separable from each other.

Although terms including ordinal numbers, such as such as “first”, “second”, etc., may be used to describe various constituent elements, the constituent elements are not limited to the terms. The terms may be used only as names for distinguishing one constituent element from another constituent element, and meaning of the order between the constituent elements may be identified through context of the description of the constituent elements in place of the names.

The term “and/or” is used to include a combination of any of a plurality of items associated therewith. For example, the phrase “A or B” will be understood to include three cases of “A”, “B” and “A and B” on the whole.

In the case where an element is described as being “connected” or “linked” to another element, it should be understood that the element may be directly connected or linked to the other element, or another element may be present therebetween.

It should be noted that terms used herein are merely used to describe a specific embodiment, not to limit the present disclosure. Incidentally, unless clearly used otherwise, singular expressions include a plural meaning. In this application, the term “comprising” “including” or the like, is intended to express the existence of the characteristic, the numeral, the step, the operation, the element, the part, or the combination thereof, and does not exclude another characteristic, numeral, step, operation, element, part, or any combination thereof, or any addition thereto.

Unless defined otherwise, terms used herein including technological or scientific terms have the same meaning as generally understood by those of ordinary skill in the art to which the disclosure pertains. The terms used herein shall be interpreted not only based on the definition of any dictionary but also the meaning that is used in the field to which the disclosure pertains. In addition, unless clearly defined, the terms used herein shall not be interpreted too ideally or formally.

In addition, the term “unit”, “control unit”, “control device” or “controller” is only a term widely used for designation of an appliance for controlling a function associated therewith and, as such, does not mean a generic functional unit. For example, the appliance may include a communication device configured to communicate with another controller or a sensor, for control of a function to be performed thereby, a recording medium that can be read by a computer and is configured to store an operating system, logic commands, input/output information, etc., and at least one processor configured to execute comparison, discrimination, calculation, determination, etc. required for control of the function to be performed.

Meanwhile, the processor may include a semiconductor integrated circuit and/or electronic elements configured to execute at least one or more of comparison, discrimination, calculation, and determination in order to achieve a programmed function. For example, the processor may be one or a combination of a computer, a microprocessor, a central processing unit (CPU), an application specific integrated circuit (ASIC), circuitry, and logic circuits.

In addition, the recording medium that can be read by a computer (or simply referred to as a memory) includes all kinds of storage devices, on which data that can be read by a computer system is stored. For example, the recording medium may include at least one of memories of a flash memory type, a hard disk type, a micro-disk type, a card type (for example, a secure digital (SD) card type, an extreme digital (XD) card type), etc., and memories of a random access memory (RAM) type, a static RAM (SRAM) type, a read-only memory (ROM) type, a programmable ROM (PROM) type, an electrically erasable PROM (EEPROM) type, a magnetic RAM (MRAM) type, a magnetic disk type, and an optical disc type.

Such a recording medium may be electrically connected to a processor, and the processor may read out data from the recording medium, and may write the read-out data. The recording medium and the processor may be integrated with each other or may be separated from each other.

Hereinafter, the accompanying drawings will be briefly described, and embodiments of the present disclosure will be described in detail with reference to the accompanying drawings.

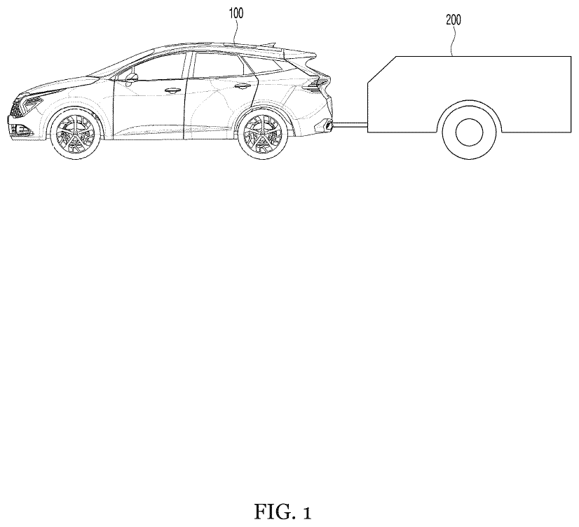

FIG. 1 is a view for briefly describing a charging system of an electric mobility apparatus according to an embodiment.

Referring to FIG. 1, the charging system of the electric mobility apparatus according to the embodiment uses a second (or add-on) electric mobility apparatus 200 which is a trailer type electric mobility apparatus for power supply. Here, the second electric mobility apparatus 200 may be selectively connected to a power system of a first electric mobility apparatus 100 which is an electric vehicle.

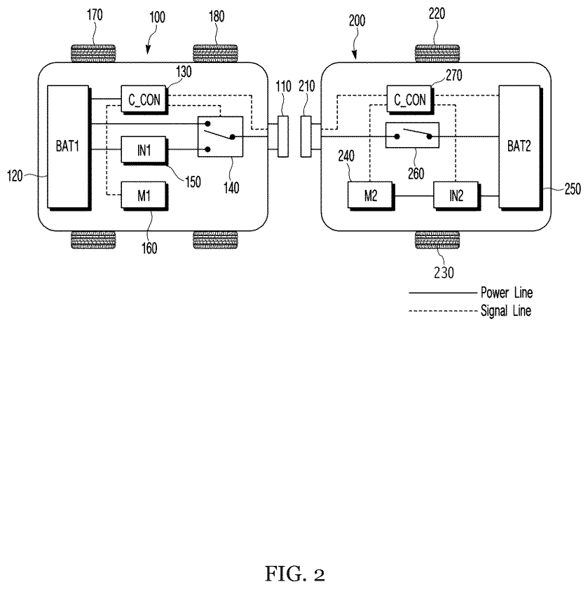

In other words, a first high-voltage battery 120 (FIG. 2) mounted in the first electric mobility apparatus 100 is recharged using a second high-voltage battery 250 (FIG. 2) which is an auxiliary battery mounted in the second electric mobility apparatus 200.

Here, the second electric mobility apparatus 200, which is of a trailer type, may be towed by the first electric mobility apparatus 100 and, as such, may run together with the first electric mobility apparatus 100.

Accordingly, the first electric mobility apparatus 100 may be driven through additional use of electric power of the second high-voltage battery 250 and, as such, the driving range of the first electric mobility apparatus 100 may be increased.

Meanwhile, when a state of charge (SoC) of the second high-voltage battery 250 reaches a limit value thereof, the first electric mobility apparatus 100 cannot receive electric power from the second electric mobility apparatus 200.

In this case, the driver of the first electric mobility apparatus 100 may move the first electric mobility apparatus 100 to a station where the second electric mobility apparatus 200 is replaceable with an electric mobility apparatus for power supply having a high SoC.

However, when the point where the first electric mobility apparatus 100 is disposed is too far from the point where the station is disposed, and the SoC of the first high-voltage battery 120 is also low, it may be possible to simultaneously recharge the second electric mobility apparatus 200 and the first electric mobility apparatus 100 using an external charger disposed around the first electric mobility apparatus 100.

In an embodiment, the external charger recharges the second electric mobility apparatus 200, and the first electric mobility apparatus 100 is recharged through the second electric mobility apparatus 200, and, as such, it may be possible to cope with a dangerous situation possibly occurring during recharging of the first electric mobility apparatus 100.

Hereinafter, a detailed description will be given of the above-described case.

FIG. 2 is a view explaining a charging system of an electric mobility apparatus according to an embodiment.

In FIG. 2, the second electric mobility apparatus 200 may be in a state of being electrically connected to an external charger (not shown), for recharging of the second high-voltage battery 250. In other words, the condition that the first electric mobility apparatus 100 may cope with a dangerous situation is the condition that only the second electric mobility apparatus 200 is electrically connected to the external charger in a state in which both the first electric mobility apparatus 100 and the second electric mobility apparatus 200 are stopped. Here, the second electric mobility apparatus 200 is electrically/mechanically connected to a charging plug of the external charger (not shown) through an external charging port (not shown). Since the external charging port (not shown) and the charging plug are in a mechanically locked state, the second electric mobility apparatus 200 should be maintained in a stopped state during recharging of the second high-voltage battery 250.

Meanwhile, in FIG. 2, the charging system of the electric mobility apparatus, that is, the charging system of the first electric mobility apparatus 100, may include a first connector 110, a first high-voltage battery 120, and a charging controller 130. In addition, the charging system may further include a first switch circuit 140 and a first inverter 150.

In addition, the charging system may further include a connector locker (not shown) configured to operate in a lock mode during recharging of the first high-voltage battery 120, thereby preventing disconnection of the first connector 110 from a second connector 210. The connector locker may comprises a latch which is operated by motorized power or solenoidal power to move between a first position (lock mode) and a second position (unlock mode) so as to hook or unhook the second connector 210.

The first connector 110 may be releasably connected to the second connector 210 of the second electric mobility apparatus 200 which is an electric mobility apparatus for power supply.

Although the first connector 110 is shown in FIG. 2 as being connected to one signal line and one power line, two or more signal lines and two or more power lines may be connected to the first connector 110. If necessary, the first connector 110 may be connected to only the power line, and the signal line may be connected to a separate connector.

The first high-voltage battery 120 may be fixedly installed at a body of the first electric mobility apparatus 100, for example, a lower surface of a bottom of a passenger compartment.

The first high-voltage battery 120 described above may supply electric power to a first drive motor 160. In this case, the first high-voltage battery 120 may supply high-voltage power of 300V or more to the first drive motor 160. The first drive motor 160 receiving electric power from the first high-voltage battery 120 may supply drive force to one or more of a pair of front wheels 170 and a pair of rear wheels 180. Although the first electric mobility apparatus 100 is shown in FIG. 2 as including only the first drive motor 160, for convenience of description, embodiments are not limited thereto, and the first electric mobility apparatus 100 may include two drive motors (a dual motor) or may include two or four in-wheel motors.

In an embodiment, the first drive motor 160 may be an alternating current (AC) motor. In this case, since electric power of the first high-voltage battery 120 is direct current (DC) power, the first inverter 150, which convers DC power into AC power, may be disposed between the first high-voltage battery 120 and the first drive motor 160.

Meanwhile, the first high-voltage battery 120 may be connected to a low-voltage battery (not shown) through a low-voltage DC/DC converter (not shown) to recharge the low-voltage battery (not shown). In this case, the low-voltage battery (not shown) may be, for example, a 12V or 24V battery, and may supply low-voltage power to an electric device such as an air conditioner of the first electric mobility apparatus 100, an audio, video and navigation (AVN) device, etc. configured to operate at a low voltage,

The first high-voltage battery 120 may be recharged through an external charger (not shown) or the second electric mobility apparatus 200.

When the external charger (not shown) is a standard charger configured to supply AC power, an on-board charger (OBC) of the first electric mobility apparatus 100 may recharge the first high-voltage battery 120 by converting AC power into DC power.

The first high-voltage battery 120 described above may include a plurality of battery cells (not shown) configured to output a unit voltage of, for example, 2.7 to 4.2V, and the plurality of battery cells may be interconnected in series/parallel in groups each including a predetermined number of battery cells. In addition, the first high-voltage battery 120 may take the form in which two or more battery modules are interconnected in series/parallel to be packaged into one battery package, in order to output a desired output voltage, for example, about 400V, about 800V, or several kV.

In addition, the first high-voltage battery 120 may include a battery management system (BMS).

The battery management system may include a battery management unit (BMU), a cell monitoring unit (CMU), and a battery junction box (BJB).

The battery management system may perform a cell balancing function for maintaining a voltage of the battery cells to be constant, thereby securing performance of the entirety of the battery package, a state-of-charge (SoC) function for calculating the capacity of the entirety of the battery system, control of battery cooling, recharging, and discharging, etc.

The battery management unit receives information of all battery cells from the cell monitoring unit, and performs the functions of the battery management system based on the received information.

For example, the battery management unit may be constituted by two microcontroller units (MCUs), and each microcontroller unit has one controller area network (CAN) communication port. Concretely, each microcontroller unit may include a CAN interface in order to enable the microcontroller unit to communicate with a vehicle controller which may be an upper-level device of the battery management system, and may include a CAN interface configured to collect information of the cell monitoring unit which may be a lower-level device of the battery management system.

The cell monitoring unit may be directly attached to a battery cell to sense a voltage, a current, a temperature, etc. of the battery cell. The cell monitoring unit may perform only a simple sensing function without performing calculation associated with a BMS algorithm. A plurality of battery cells may be connected to one cell monitoring unit and, as such, may transmit information of respective battery cells to the battery management unit via the CAN interface.

The battery junction box is not only a pack-level sensing mechanism of the battery management system, but also a connection medium between the first high-voltage battery 120 and a drivetrain. The battery junction box measures and records a battery voltage and a current flowing through the battery in order to correctly calculate an SoC. In addition, the battery junction box may perform a function important for safety, such as overcurrent sensing and insulation monitoring.

The charging controller 130 may transmit, to the first high-voltage battery 120, charging power input to the first connector 110, that is, charging power (DC power) supplied from the second electric mobility apparatus 200, thereby recharging the first high-voltage battery 120.

In addition, the charging controller 130 may transmit a charging stop signal requesting supply stop of charging power to the second electric mobility apparatus 200, which is an electric mobility apparatus for power supply, when a predetermined emergency charging stop condition is satisfied during recharging of the first high-voltage battery 120.

In detail, the charging controller 130 may control the first switch circuit 140 to electrically interconnect the first switch circuit 140 and the first high-voltage battery 120. Accordingly, charging power input to the first connector 110 may be transmitted to the first high-voltage battery 120 and, as such, may recharge the first high-voltage battery 120. When the voltage of the charging power, that is, the voltage of the charging power supplied from the second electric mobility apparatus 200, is lower than a voltage required for recharging of the first high-voltage battery 120, a high-voltage DC/DC converter (not shown) may be disposed between the first switch circuit 140 and the first high-voltage battery 120.

When the voltage of the charging power is higher than the recharging voltage, a low-voltage DC/DC converter (not shown) may be disposed between the first switch circuit 140 and the first high-voltage battery 120.

In an embodiment, when the SoC of the first high-voltage battery 120 is lower than a predetermined lower limit, the charging controller 130 may electrically interconnect the first switch circuit 140 and the first high-voltage battery 120.

When the SoC of the first high-voltage battery 120 reaches a predetermined upper limit in the state described above, the charging controller 130 may release electrical interconnection between the first switch circuit 140 and the first high-voltage battery 120 by controlling the first switch circuit 140.

Meanwhile, when only the second electric mobility apparatus 200 is electrically connected to an external charger (not shown), for recharging of the first high-voltage battery 120, the charging controller 130 may output, through an AVN device, a message inquiring, to the driver of the first electric mobility apparatus 100, whether or not a dangerous situation coping mode should be selected.

When the driver selects the dangerous situation coping mode through the AVN device or a physical button of the first electric mobility apparatus 100, the charging controller 130 may set the first electric mobility apparatus 100 to an EV READY state. In addition, the charging controller 130 may transmit, to the second electric mobility apparatus 200, an IG ON setting signal for setting the second electric mobility apparatus 200 to an IG ON state.

Here, the EV READY state may mean a state in which all controllers of the electric mobility apparatus are in an active state, and driving of the drive motor is possible. In addition, the IG ON state may mean a state in which all controllers of the electric mobility apparatus are in an active state, but driving of the drive motor is impossible.

The discharging controller 130 described above may recharge the first high-voltage battery 120 in the EV READY state.

In addition, the charging controller 130 may receive various information from one or more of an impact sensor, an object sensor, and the battery management system of the first electric mobility apparatus 100, and may compare the received information with a predetermined emergency charging stop condition, thereby determining whether or not a dangerous situation has occurred during charging of the first electric mobility apparatus 100.

Here, the emergency charging stop condition may include one or more of a first condition that an impact amount sensed by the impact sensor of the first electric mobility apparatus 100 is not less than a predetermined first reference value and a second condition that a time taken for the object sensor of the first electric mobility apparatus 100 to continuously sense one or more objects is not less than a predetermined second reference value.

For example, an unidentified person may break the first electric mobility apparatus 100 in order to threaten the driver seated in the first electric mobility apparatus 100 in a state in which the first electric mobility apparatus 100 and the second electric mobility apparatus 200 are stopped for recharging of the second electric mobility apparatus 200 using an external charger (not shown).

In an embodiment, in this case, the charging controller 130 may compare the impact amount sensed by the impact sensor with the predetermined first reference value, and may determine that the first condition is satisfied when the impact amount is not less than the predetermined first reference value, that is, may determine that a dangerous situation has occurred during charging.

When the impact amount sensed by the impact sensor is less than the first reference value, the charging controller 130 may determine that no dangerous situation has occurred during charging, because the sensed impact amount may be a light impact generated due to a cause other than threat,

In another embodiment, one or more unidentified people may walk around the first electric mobility apparatus 100 for quite a long time in a state in which the first electric mobility apparatus 100 and the second electric mobility apparatus 200 are stopped for recharging of the second electric mobility apparatus 200 using an external charger (not shown).

In an embodiment, the charging controller 130 may compare the time taken for the object sensor to continuously sense one or more objects (for example, one or more unidentified people) with the predetermined second reference value, and may determine that the second condition is satisfied when the time is not less than the predetermined second reference value, that is, may determine that a dangerous situation has occurred during charging.

When the time taken for the object sensor to continuously sense one or more objects is less than the predetermined second reference value, the charging controller 130 may determine that no dangerous situation has occurred during charging, because the sensing of the object sensor may be caused by passage of passers-by, vehicles, etc. around the first electric mobility apparatus 100. Here, the object sensor may be an ultrasonic sensor, an image sensor, a radar sensor, a LiDAR sensor, or the like.

Upon determining that the current situation of the first electric mobility apparatus 100 satisfies the first condition or the second condition, the charging controller 130 may transmit a charging stop signal requesting supply stop of charging power to the second electric mobility apparatus 200 which is an electric mobility apparatus for power supply. In this case, the charging controller 130 may output a message informing of condition satisfaction through an image or an audible sound before transmission of the charging stop signal, and may transmit the charging stop signal upon receiving a response signal of the driver to the notification message.

When the charging controller 130 does not receive a response signal of the driver to the notification message, the charging controller 130 may not transmit the charging stop signal.

In other words, the charging controller 130 may receive a final determination of the driver as to occurrence of a dangerous situation during charging and, as such, may transmit or may not transmit the charging stop signal. Here, the response signal of the driver may include one or more of an accelerator position sensor (APS) signal as to accelerator pedal manipulation of the driver and a function selection signal as to AVN device manipulation of the driver.

Meanwhile, when the charging system includes a connector locker (not shown), the charging controller 130 may control the connector locker (not shown) to operate in a release mode after transmitting the charging stop signal to the second electric mobility apparatus 200.

Accordingly, the first connector 110 and the second connector 210 may enter a releasable state.

In the dangerous situation coping mode, the driver may drive the first electric mobility apparatus 100 by directly manipulating the accelerator pedal without a procedure of pressing a start button of the first electric mobility apparatus 100 because the first electric mobility apparatus 100 is in the EV READY state. Accordingly, the first electric mobility apparatus 100 may escape from a location where the dangerous situation has occurred, without breakage of the first connector 110.

The charging controller 130 may drive the first drive motor 160 by itself upon controlling the connector locker (not shown) to operate in the release mode. In other words, autonomous driving of the first electric mobility apparatus 100 may be performed.

When the driver manipulates the accelerator pedal in a state in which the emergency charging stop condition is not satisfied in the dangerous situation coping mode, the charging controller 130 may limit driving of the first drive motor 160 for fail safe.

Meanwhile, in an embodiment, the emergency charging stop condition may further include a third condition that a first battery temperature, which is a temperature of the first high-voltage battery 120, is not less than a predetermined third reference value, a fourth condition that a first SoC, which is an SoC of the first high-voltage battery 120, is not less than a predetermined fourth reference value, a fifth condition that a first connector temperature, which is a temperature of the first connector, is not less than a predetermined fifth reference value, and a sixth condition that a charging current amount is not less than a predetermined sixth reference value.

For example, when the first high-voltage battery 120 is overheated during recharging thereof, the possibility that fire is generated at the first electric mobility apparatus 100 may be increased.

In an example, the charging controller 130 may compare the first battery temperature measured by the battery management system with the predetermined third reference value, and may determine that the third condition is satisfied, when the first battery temperature is not less than the predetermined third reference value, that is, may determine that a dangerous situation has occurred during recharging.

When the first battery temperature is less than the predetermined third reference value, the first high-voltage battery 120 is not in an overheated state and, as such, the charging controller 130 may determine that no dangerous situation has occurred during recharging.

In another example, when the first high-voltage battery 120 is excessively recharged during recharging thereof, the possibility that fire is generated at the first electric mobility apparatus 100 may be increased.

In an example, the charging controller 130 may compare the first SoC measured by the battery management system with the predetermined fourth reference value, and may determine that the fourth condition is satisfied, when the first SoC is not less than the predetermined fourth reference value, that is, may determine that a dangerous situation has occurred during recharging.

When the first SoC is less than the predetermined fourth reference value, the first high-voltage battery 120 is not in an over-charged state and, as such, the charging controller 130 may determine that no dangerous situation has occurred during recharging.

In another example, when the first connector 110 is overheated due to erroneous contact between the first connector 110 and the second connector 210 during recharging of the first high-voltage battery 120, the possibility that fire is generated at the first electric mobility apparatus 100 may be increased.

In an example, the charging controller 130 may compare the first connector temperature measured by the battery management system with the predetermined fifth reference value, and may determine that the fifth condition is satisfied, when the first connector temperature is not less than the predetermined fifth reference value, that is, may determine that a dangerous situation has occurred during recharging.

When the first connector temperature is less than the predetermined fifth reference value, the first high-voltage battery 120 is not in an overheated state and, as such, the charging controller 130 may determine that no dangerous situation has occurred during recharging.

In another example, when overcurrent is generated during recharging of the first high-voltage battery 120, the possibility that fire is generated at the first electric mobility apparatus 100 may be increased.

In an example, the charging controller 130 may compare the charging current amount measured by the battery management system with the predetermined sixth reference value, and may determine that the sixth condition is satisfied, when the charging current amount is not less than the predetermined sixth reference value, that is, may determine that a dangerous situation has occurred during recharging.

When the charging current amount is less than the predetermined sixth reference value, no overcurrent has been generated at the first high-voltage battery 120 and, as such, the charging controller 130 may determine that no dangerous situation has occurred during recharging.

Upon determining that the current situation of the first electric mobility apparatus 100 satisfies one or more of the third to sixth conditions, the charging controller 130 may transmit the charging stop signal requesting supply stop of charging power to the second electric mobility apparatus 200 which is an electric mobility apparatus for power supply.

Meanwhile, when the charging system includes the connector locker (not shown), the charging controller 130 may control the connector locker (not shown) to operate in a release mode after transmitting the charging stop signal to the second electric mobility apparatus 200.

Accordingly, the first connector 110 and the second connector 210 enter a releasable state.

Since the first electric mobility apparatus 100 is in the EV READY state in the dangerous situation coping mode, the charging controller 130 may drive the first drive motor 160 by itself. Accordingly, the first electric mobility apparatus 100 may move to be spaced apart from the second electric mobility apparatus 200 by a predetermined distance or more without breakage of the first connector 110.

In order words, when there is a possibility that fire is generated at the first electric mobility apparatus 100, the charging controller 130 may control the first electric mobility apparatus 100 to perform autonomous driving thereof, thereby enabling the first electric mobility apparatus 100 to secure a safe distance from the second electric mobility apparatus 200. Accordingly, even when fire is generated at the first electric mobility apparatus 100, it may be possible to prevent propagation of fire to the second electric mobility apparatus 200.

As apparent from the above description, when the current situation of the first electric mobility apparatus 100 in the dangerous situation coping mode satisfies the emergency charging stop condition, that is, is a dangerous situation, the charging controller 130 may transmit the charging stop signal to the second electric mobility apparatus 200, thereby releasing electrical connection between the first electric mobility apparatus 100 and the second electric mobility apparatus 200. Thereafter, it may be possible to escape the dangerous situation through accelerator pedal manipulation of the driver or autonomous driving of the first electric mobility apparatus 100.

The charging controller 130 described above may be a vehicle control unit (VCU) of the first electric mobility apparatus 100.

Meanwhile, as shown in FIG. 2, the second electric mobility apparatus 200, which receives the IG ON setting signal, the charging stop signal, etc. from the charging controller 130, may include the second connector 210 releasably connected to the first connector 110, a right wheel 220, a left wheel 230, and a second drive motor 240 configured to supply drive force to one or more of the right wheel 220 and the left wheel 230.

In addition, the second electric mobility apparatus 200 may also include the second high-voltage battery 250, which supplies electric power to the second drive motor 240 and outputs charging power to the second connector 210, a discharge switch circuit 260 configured to electrically interconnect the second connector 210 and the second high-voltage battery 250 in an ON state thereof while disconnecting electrical connection between the second connector 210 and the second high-voltage battery 250 in an OFF state thereof, and a discharge controller 270 configured to control ON/OFF of the discharge switch circuit 260 while switching the discharge switch circuit 260 from the ON state to the OFF state upon receiving the charging stop signal through the second connector 210.

In addition, the second electric mobility apparatus 200 may further include an external charging port (not shown) electrically/mechanically connected to a charging plug of an external charger (not shown).

In this case, the discharge controller 270 may receive the IG ON setting signal transmitted from the charging controller 130 through the second connector 210 before receiving the charging stop signal.

Upon receiving the IG ON setting signal, the discharge controller 270 may set the second electric mobility apparatus 200 to the IG ON state, that is, may set all controllers of the second electric mobility apparatus 200 to be an active state while setting the second drive motor 240 to a driving-impossible state.

In the IG ON state of the second electric mobility apparatus 200, the discharge controller 270 may control the discharge switch circuit 260 to be in an ON state or an OFF state. When the discharge switch circuit 260 is in an OFF state, output of charging power to the second connector 210 is prevented and, as such, no charging power is input to the first connector 110.

Meanwhile, in an embodiment, the second high-voltage battery 250 mobility apparatus may be a battery having a lower voltage than that of the first high-voltage battery 10. In this case, the second electric mobility apparatus 200 may further include a high-voltage DC/DC converter (not shown) configured to boost the voltage of charging power output from the second high-voltage battery 250.

In addition, the second high-voltage battery 250 may include a battery management system (BMS), similarly to the first high-voltage battery 120.

The discharge controller 270 may check a temperature of the second high-voltage battery 250, whether or not overcurrent has been generated at the second high-voltage battery 250, etc. through the battery management system of the second high-voltage battery 250.

Through the checking, the discharge controller 270 may determine whether or not abnormal discharge of the second high-voltage battery 250 has occurred.

When abnormal discharge of the second high-voltage battery 250 has occurred, the discharge controller 270 may generate an abnormality generation signal informing of abnormal discharge of the second electric mobility apparatus 200, and may transmit the abnormality generation signal to the first electric mobility apparatus 100.

Thereafter, the discharge controller 270 may switch the discharge switch circuit 260 form an ON state to an OFF state, thereby preventing supply of charging power. The discharge controller 270 described above may be a VCU of the second electric mobility apparatus 200.

Meanwhile, upon receiving the abnormality generation signal, the charging controller 130 of the first electric mobility apparatus 100 may control the connector locker (not shown) to operate in the release mode, thereby releasing locking between the first connector 110 and the second connector 210.

In addition, the charging controller 130 may control the first drive motor 160 to be driven by itself, that is, may control the first electric mobility apparatus 100 to perform autonomous driving thereof.

Through this control, the first electric mobility apparatus 100 may move to be spaced apart from the second electric mobility apparatus 200 by a predetermined distance (a safe distance) without breakage of the first connector 110.

As apparent from the above description, the first electric mobility apparatus 100, which is charged through the second electric mobility apparatus 200 having an auxiliary battery function while taking a trailer form, may sense occurrence of a dangerous situation during charging thereof by itself and, as such, may release electrical connection thereof to the second electric mobility apparatus 200, thereby escaping a dangerous situation. Accordingly, it may be possible to cope with a dangerous situation occurring during charging of the first electric mobility apparatus 100.

Hereinafter, a procedure of coping with a dangerous situation occurring during charging of the first electric mobility apparatus 100 will be described.

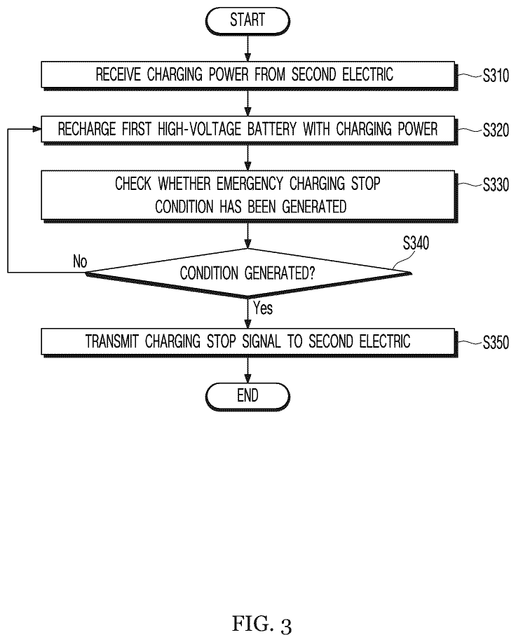

FIG. 3 is a flowchart showing a procedure of coping with a first dangerous situation occurring during charging of the first electric mobility apparatus 100 in accordance with an embodiment.

Here, the first dangerous situation may be a situation in which an identified person approaches the first electric mobility apparatus 100 being charged with charging power or a situation in which there is a possibility of generation of fire at the first electric mobility apparatus 100.

Referring to FIG. 3, the first electric mobility apparatus 100 may receive charging power from the second electric mobility apparatus 200, which is an electric mobility apparatus for power supply, through the first connector 110 releasably connected to the second connector 210 of the second electric mobility apparatus 200 (S310).

The first electric mobility apparatus 100 may check whether or not an emergency charging stop condition has been generated while recharging the first high-voltage battery 120 with charging power (S320 and S330). In this case, the first electric mobility apparatus 100 is in a state of being set to a dangerous situation coping mode and, as such, the first high-voltage battery 120 may be recharged in the EV READY state.

When no emergency charging stop condition has not been generated at step S330, recharging of the first high-voltage battery 120 may be continuously performed (S340).

When the emergency charging stop condition has been generated, that is, the emergency charging stop condition is satisfied, at step 340, the first electric mobility apparatus 100 may transmit a charging stop signal requesting supply stop of charging power to the second electric mobility apparatus 200 which is the add-on electric mobility apparatus (S350).

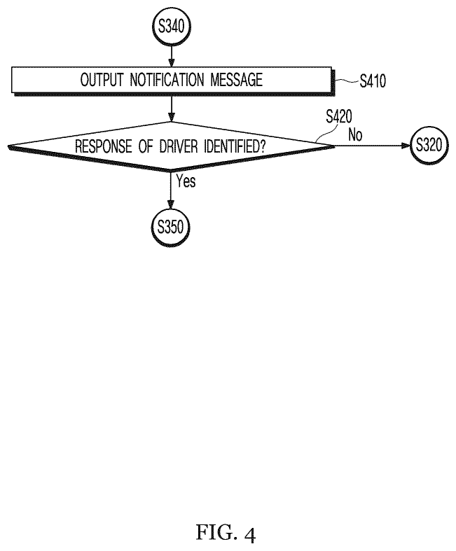

Meanwhile, after step S340, the first electric mobility apparatus 100 may output a message informing of satisfaction of the emergency charging stop condition through an image or an audible sound (S410), as shown in FIG. 4.

When a response of the driver to the notification message is identified, step S350 may be performed, whereas, when no response of the driver to the notification message is identified, step S320 may be performed (S420). Here, the response of the driver may be accelerator pedal manipulation, AVN device manipulation, etc. of the driver.

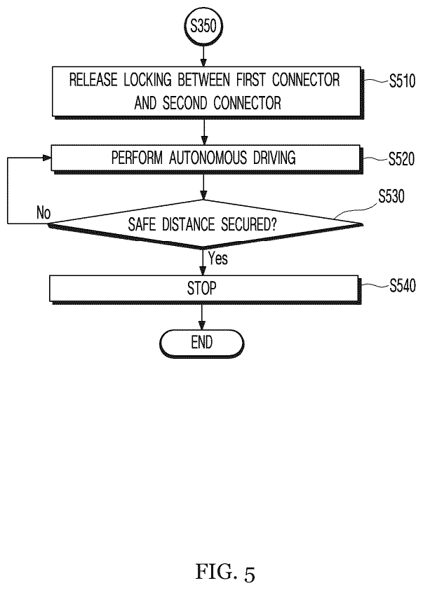

After step S350, the first electric mobility apparatus 100 may release locking between the first connector 110 and the second connector 210 (S510), as shown in FIG. 5.

The first electric mobility apparatus 100 may stop after securing a safe distance from the second electric mobility apparatus 200 through execution of autonomous driving (S520, S530, and S540). In this case, the first electric mobility apparatus 100 may perform steps S520 to S540 when the emergency charging stop condition is one or more of the third to sixth conditions.

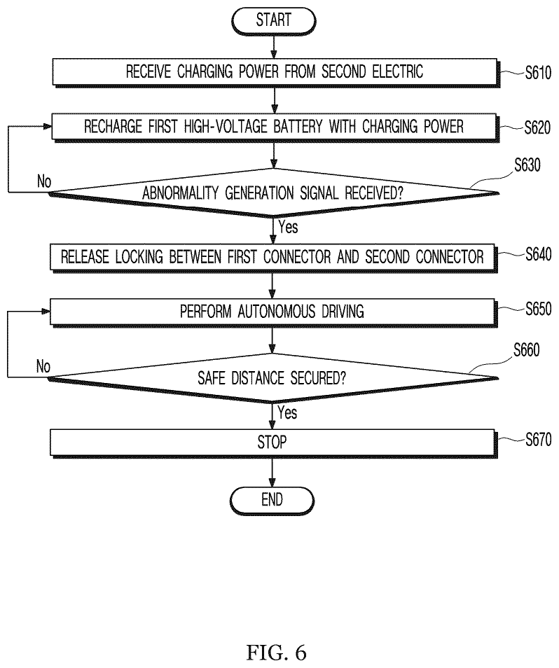

FIG. 6 is a flowchart showing a procedure of coping with a second dangerous situation during charging of the electric mobility apparatus in accordance with an embodiment.

Here, the second dangerous situation may be a situation in which the second electric mobility apparatus 200 configured to supply charging power is abnormal and, as such, there is a possibility of generation of fire.

Referring to FIG. 6, the first electric mobility apparatus 100 receives charging power from the second electric mobility apparatus 200 through the first connector 110 releasably connected to the second connector 210 of the second electric mobility apparatus 200 which is the electric mobility apparatus of power supply (S610).

The first electric mobility apparatus 100 recharges the first high-voltage battery 120 with charging power. Here, the first electric mobility apparatus 100 is in a state of being set to a dangerous situation coping mode and, as such, may recharge the first high-voltage battery 120 in the EV READY state.

Upon receiving an abnormality generation signal from the second electric mobility apparatus 200 during recharging of the first high-voltage battery 120, the first electric mobility apparatus 100 may release locking between the first connector 110 and the second connector 210 (S630 and S640).

Thereafter, the first electric mobility apparatus 100 may stop after securing a safe distance from the second electric mobility apparatus 200 through execution of autonomous driving (S650, S660, and S670).

As apparent from the above description, in accordance with the present embodiment, the electric mobility apparatus, which is charged through a trailer type auxiliary battery, may sense occurrence of a dangerous situation by itself and, as such, may release electrical connection thereof to the auxiliary battery, thereby escaping the dangerous situation. Accordingly, it may be possible to cope with a dangerous situation occurring during charging of the electric mobility apparatus.

While the embodiments of the disclosure have been described with reference to the accompanying drawings, it should be understood by those skilled in the art that various modifications may be made without departing from the scope of the disclosure and without changing essential features thereof. Therefore, the above-described embodiments should be considered in a descriptive sense only and not for purposes of limitation.

1. A charging system of a first electric mobility apparatus comprising:
a first connector releasably connected to a second connector of a second electric mobility apparatus;
a first battery configured to supply electric power to a first drive motor of the first electric mobility apparatus; and
a charging controller configured to transmit charging power input through the first connector to the first battery, thereby recharging the first battery with the transmitted charging power, and to transmit a charging stop signal requesting supply stop of the charging power to the second electric mobility apparatus when a predetermined emergency charging stop condition is satisfied during the recharging of the first battery.

2. The charging system according to claim 1, wherein the charging controller recharges the first battery in an EV READY state.

3. The charging system according to claim 2, further comprising a connector locker configured to lock or unlock connection between the first connector and the second connector,
wherein the charging controller controls the connector locker to lock the connection during the recharging of the first battery, and unlock the connection after transmitting the charging stop signal to the second electric mobility apparatus.

4. The charging system according to claim 3, wherein the charging controller controls the first drive motor to be driven after the connector locker unlock the connection.

5. The charging system according to claim 2, wherein the predetermined emergency charging stop condition comprises one or more of a first condition that an impact amount sensed by an impact sensor of the first electric mobility apparatus is equal to or greater than a predetermined first reference value or a second condition that a time period taken for an object sensor of the electric mobility apparatus to continuously sense one or more objects is equal to or greater than a predetermined second reference value.

6. The charging system according to claim 5, wherein the charging controller outputs a notification message when one or more of the first condition or the second condition are satisfied, and transmits the charging stop signal to the second electric mobility apparatus upon receiving a response signal of a driver to the notification message.

7. The charging system according to claim 6, wherein the response signal comprises one or more of an accelerator position sensor (APS) signal as to accelerator pedal manipulation of the driver or a function selection signal as to audio, video and navigation (AVN) device manipulation of the driver.

8. The charging system according to claim 5, wherein the predetermined emergency charging stop condition further comprises a third condition that a first battery temperature of the first battery is equal to or greater than a predetermined third reference value, a fourth condition that a first state of charge (SoC) of the first battery is equal to or greater than a predetermined fourth reference value, a fifth condition that a first connector temperature of the first connector is equal to or greater than a predetermined fifth reference value, or a sixth condition that a charging current amount is equal to or greater than a predetermined sixth reference value.

9. The charging system according to claim 8, wherein, upon determining that one or more of the third, fourth, fifth, or sixth condition are satisfied, the charging controller controls a connector locker to unlock the connection between the first connector and the second connector, and then controls the first drive motor to be driven, thereby causing the first electric mobility apparatus to be spaced apart from the second electric mobility apparatus by a predetermined distance or more.

10. The charging system according to claim 2, wherein the second electric mobility apparatus comprises:
a right wheel;
a left wheel;
a second drive motor configured to supply drive force to one or more of the right wheel and the left wheel;
a second battery configured to supply electric power to the second drive motor and to output the charging power to the second connector;
a discharge switch circuit configured to electrically interconnect the second connector and the second battery in an ON state while disconnecting electrical connection between the second connector and the second battery in an OFF state; and
a discharge controller configured to control ON/OFF state of the discharge switch circuit, wherein the discharge controller switches the discharge switch circuit from the ON state to the OFF state upon receiving the charging stop signal through the second connector.

11. The charging system according to claim 10, wherein the discharge controller controls the discharge switch circuit to be in an ON state or an OFF state, in an IG ON state.

12. A method of charging a first electric mobility apparatus, comprising:
receiving charging power from a second electric mobility apparatus through a first connector releasably connected to a second connector of the second electric mobility apparatus;
recharging a first battery of the first electric mobility apparatus with the charging power; and
transmitting a charging stop signal requesting supply stop of the charging power to the second electric mobility apparatus when a predetermined emergency charging stop condition is satisfied during the recharging of the first battery.

13. The method according to claim 12, wherein, in the recharging, the first electric mobility apparatus recharges the first battery in an EV READY state.

14. The method according to claim 13, further comprising:
unlocking the connection between the first connector and the second connector after the transmitting.

15. The method according to claim 13, wherein the predetermined emergency charging stop condition comprises one or more of a first condition that an impact amount sensed by an impact sensor of the first electric mobility apparatus is equal to or greater than a predetermined first reference value or a second condition that a time period taken for an object sensor of the first electric mobility apparatus to continuously sense one or more objects is equal to or greater than a predetermined second reference value.

16. The method according to claim 15, wherein the transmitting comprises:
outputting a notification message when one or more of the first condition or the second condition are satisfied; and
transmitting the charging stop signal to the second electric mobility apparatus upon identifying a response signal of a driver to the notification message.

17. The method according to claim 15, wherein the predetermined emergency charging stop condition further comprises a third condition that a first battery temperature of the first battery is equal to or greater than a predetermined third reference value, a fourth condition that a first state of charge (SoC) of the first battery is equal to or greater than a predetermined fourth reference value, a fifth condition that a first connector temperature of the first connector is equal to or greater than a predetermined fifth reference value, or a sixth condition that a charging current amount is equal to or greater than a predetermined sixth reference value.

18. The method according to claim 17, further comprising:
unlocking the connection between the first connector and the second connector after the transmitting; and
performing autonomous driving, thereby causing the first electric mobility apparatus to be spaced apart from the second electric mobility apparatus by a predetermined distance or more.

19. The method according to claim 12, wherein the second electric mobility apparatus supplies the charging power in an IG ON state, stops supply of the charging power upon receiving the charging stop signal from the first electric mobility apparatus, and is then switched to an IG OFF state.

20. A method of charging a first electric mobility apparatus, comprising:
receiving charging power from a second electric mobility apparatus through a first connector releasably connected to a second connector of the second electric mobility apparatus;
recharging a first battery of the first electric mobility apparatus with the charging power;
receiving, from the second electric mobility apparatus, an abnormality generation signal informing of abnormal discharge of electric power of the second electric mobility apparatus;
unlocking the connection between the first connector and the second connector; and
performing autonomous driving, thereby causing the first electric mobility apparatus to be spaced apart from the second electric mobility apparatus by a predetermined distance or more.
